(19) United States
(12) Patent Application Publication
(10) Pub. No.: US 2006/0191840 A1
(43) Pub. Date: Aug. 31, 2006

(54) Fluid filter apparatus for vehicle and manufacturing method thereof

(75) Inventor: Nobuyuki Homi, Hiroshima (JP)

Correspondence Address: NIXON PEABODY, LLP, 401 9TH STREET, NW, SUITE 900, WASHINGTON, DC, 20004-2128, US

(73) Assignee: GP Daikyo Corporation, Higashihiroshima-shi (JP)

(21) Appl. No.: 11/290,466

(22) Filed: Dec. 1, 2005

(30) Foreign Application Priority Data
Feb. 28, 2005 (JP) 2005-053884

(51) Int. Cl. B01D 35/28

(52) U.S. Cl. 210/435; 210/446; 180/337

(57) ABSTRACT

An upper half casing member is made of a resin capable of transmitting laser light while a lower half casing member is made of a resin incapable of transmitting laser light. An upper flange portion and a lower flange portion are formed at the respective casing members so as to protrude outwards of a casing from respective peripheral walls thereof. A housing concave part and an upper contact face are formed in the lower face portion of the upper flange portion. A lower contact face is formed in the upper face of the lower flange portion. Laser light is irradiated to the lower flange portion through the upper flange portion to weld the contact faces to each other and to weld an element welding face at the upper face of the lower flange portion to a peripheral part of a filter element.

### CROSS REFERENCE TO RELATED APPLICATIONS

This Non-provisional application claims priority under 35 U.S.C. § 119(a) on Patent Application No. 2005-053884 filed in Japan on Feb. 28, 2005, the entire contents of which are hereby incorporated by reference.

### BACKGROUND ART

The present invention relates to a fluid filtering apparatus for a vehicle which is used for filtering oil circulating within an automatic transmission of an automobile, for example, and a method for manufacturing it.

As disclosed in Japanese Patent Application Laid Open Publication No. 2004-148592A, for example, a conventional fluid filtering apparatus for a vehicle has been known which includes a resin-made casing and a filter element disposed within the casing for filtering oil. This casing of the fluid filtering apparatus is composed of an assembly of a first half casing member and a second half casing member. The first half casing member includes a end wall in which an oil inlet is formed and a peripheral wall protruding from the periphery of the end wall towards the second half casing member. The second half casing member includes an end wall in which an oil outlet is formed and a peripheral wall protruding from the periphery of the end wall towards the first half casing member.

Contact faces are formed at the edges, which face each other, of the peripheral walls of the first half casing member and the second half casing member so as to be in contact with each other. The contact faces are welded so that the casing members are integrated with each other. The peripheral part of the filter element is held between parts further inside the casing than the contact faces of the casing members. The peripheral part of the filter element is welded to the casing members with the resin melted at welding the contact faces, thereby preventing the filter element from falling off from the casing at oil filtering.

Patent Document 1 also discloses that laser welding can be employed for welding the contact faces of the first half casing member and the second half casing member to each other. In a case employing the laser welding, laser light is irradiated from a laser light emitter to the contact faces from the outside of the casing members to melt the contact faces of the casing members by the energy of the laser light, thereby integrating the casing members with each other. In irradiation of the laser light, in general, the laser light is oriented substantially at a right angle to the contact faces for melting desired parts of the contact faces to obtain high welding strength.

In the case where the edges of the peripheral walls of the casing members serves as the contact faces as in Patent Document 1, in order to irradiate the laser light in a direction intersecting substantially at a right angle to the contact faces, the laser light is required pass through one of the peripheral wall in a direction that the peripheral wall protrudes to reach the contact faces by irradiating it from the end wall side of the peripheral wall. The irradiation that allows the laser light to pass through the peripheral wall dampens the energy of the laser light in the peripheral wall until it reaches the contact faces, and accordingly, the output level of the laser light emitter must be set high taking account of the amount of dampened energy. In this connection, a large-scale and high-output laser light emitter is required, which increases the cost of facilities, and in turn, increases the cost of the fluid filtering apparatus.

The present invention has been made in view of the above problems and has its object of providing a low-cost fluid filtering apparatus with the strength at the welded parts ensured by suppressing high output of the laser light emitter in welding the contact faces of the casing members to each other and the peripheral part of the filter element to one of the casing members by laser welding.

### SUMMARY OF THE INVENTION

In order to attain the above object, the first invention provides a fluid filtering apparatus for a vehicle which is provided with a casing composed of a casing member in which a fluid inlet is formed and another casing member in which a fluid outlet is formed and a filter element arranged within the casing for filtering a fluid flowing in the fluid inlet and in which flange portions formed at peripheries of the casing members so as to protrude outwards of the casing are welded to each other to integrated the casing members with each other and to hold the filter member by the casing members.

Wherein, one of the casing members is made of a resin capable of transmitting laser light while the other casing member is made of a resin incapable of transmitting laser light, contact faces in contact with each other are formed in peripheral parts of the flange portions of the casing members, a housing concave part for housing a peripheral part of the filter element is formed in a part further inside the casing than at least one of the contact faces of the flange portions, at least the peripheral part of the filter element having transmittance for laser light, and the contact face of the flange portion of the other casing member is welded to the contact face of the flange portion of the one casing member by melting the contact face of the flange portion of the other casing member by irradiating laser light to the contact face of the flange portion of the other casing member through the flange portion of the one casing member while an inner face located inside the flange portion of the other casing member is welded to the peripheral part of the filter element by melting the contact face of the flange portion of the other casing member by irradiating laser light to the contact face of the flange portion of the other casing member through the flange portion of the one casing member.

In the above constitution, when the laser light is irradiated to the flange portions of the other casing member through the flange portion of the one of the casing member in the state in which the peripheral part of the filter element is housed in the housing concave part, the laser light passes through the flange portion of the one casing member and reaches the flange portion of the other casing member. The other casing member does not transmit the laser light, so that the contact face of the flange portion of the other casing member is melted to allow both the contact faces of the flange portions of the casing members to be welded to each other.

Further, when the laser light is irradiated to a part of the flange portion which corresponds to the peripheral part of the filter element through the flange portion of the one casing member, the laser light passes through the peripheral part of the filter element, which is capable of transmitting laser light, to melt the inner face located inside the flange portion of the other casing member, thereby welding the inner face located inside the flange portion of the other casing member to the peripheral part of the filter element.

At the welding, the laser light passes the flange portion of the one casing member with less or no energy dampened because the one casing member is made of a laser light transmitting resin. In addition, both the contact faces of flange portions of the casing members and the inner face located inside the flange portion of the other casing member are located at parts protruding outwards of the casing from the peripheries of the casing members, enabling the laser light to reach the contact face of the flange portion of the one casing member in a direction intersecting substantially at a right angle with the contact faces of the flange portions and the inner face located inside the flange potion of the other flange portion unlike the conventional one in which the laser light passes through the peripheral wall of the one casing member. Whereby, the welding strength at the contact faces and the welding strength at the peripheral part of the filter element can be ensured with no large-size and high-output laser light emitter necessitated, resulting in a low-cost fluid filtering apparatus.

The second invention provides a method for manufacturing the fluid filtering apparatus for a vehicle according to claim 1, including the steps of: allowing the contact faces formed in the peripheral parts of the flange portions of the casing members to be in contact with each other while housing the peripheral part of the filter element into the housing concave part formed in a part further inside the casing than at least one of the contact faces of the flange portions; and thereafter, welding the contact face of the flange portion of the other casing member to the contact face of the flange portion of the one casing member by melting the contact face of the flange portion of the other casing member by irradiating laser light to the contact face of the flange portion of the other casing member through the flange portion of the one case member and welding the inner face located inside the flange portion of the other casing member to the peripheral part of the filter element by melting the inner face located inside the flange portion of the other casing member by irradiating laser light to the inner face located inside the flange portion of the other casing member through the flange portion of the one casing member.

In the above constitution, both the contact faces of the flange portions of the casing members and the inner face located inside the flange portion of the other casing member are located at part protruding outwards of the casing from the peripheries of the casing members and the one casing member is made of resin capable of transmitting laser light. Accordingly, the welding strength at the contact faces and the welding strength at the peripheral part of the filter element can be ensured with no large-size and high-output laser light emitter necessitated, resulting in a low-cost fluid filtering apparatus.

In the second invention, it is possible that the contact faces of the flange portions are welded to each other and the inner face located inside the flange portion of the other casing member is welded to the peripheral part of the filter element under a condition that: traveling speed of the laser light traveling along the periphery part of the filter element in welding the peripheral part of the filter element to the inner face located inside the flange portion of the other casing member is set lower than traveling speed of the laser light traveling along the contact faces of the flange portions in welding the contact faces of the flange portions to each other; or an output level of the laser light for irradiation in welding the peripheral part of the filer element to the inner face located inside the flange portion of the other casing member is set higher than an output level of the laser light for irradiation in welding the contact faces of the flange portions to each other.

In the above constitution, the traveling speed of the laser light for irradiation in welding the peripheral part of the filter element is set lower than the traveling speed of the laser light for irradiation in welding the contact faces of the flange portions to each other. This allows a sufficient amount of the laser light to pass through the peripheral part of the filter element, which has comparatively low transmittance for laser light, attaining reliable melting of the inner face located inside the flange portion of the other casing. Further, when the output level of the laser light for irradiation in welding the peripheral part of the filter element is set larger than the output level of the laser light for irradiation in welding the contact faces of the flange portions, reliable melting of the inner face located inside of the flange portion can be attained, as well. As a result, welding failure of the filter element can be prevented.

### BRIEF DESCRIPTION OF THE DRAWINGS

FIG. 1 is a section taken along the line A-A in FIG. 2.

FIG. 2 is a side view of a fluid filtering apparatus according to an embodiment of the present invention.

FIG. 3 is an illustration for explaining a schematic constitution of a welding apparatus.

FIG. 4 corresponds to FIG. 1 and is a view showing the vicinity of a flange portion according to a modified example of the embodiment.

### DESCRIPTION OF THE PREFERRED EMBODIMENT

An embodiment of the present invention will be described below with reference to the accompanying drawings. Wherein, the following description of the preferred embodiment is substantially a mere example and is not intended to limit the present invention, object to which it is applied, and the use thereof.

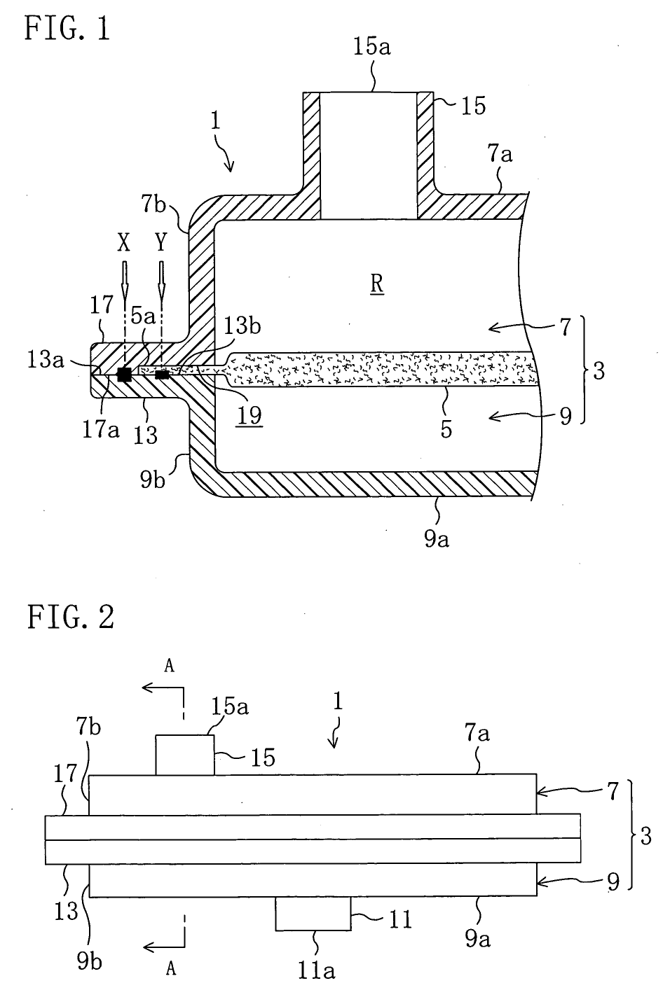

FIG. 1 shows a fluid filtering apparatus 1 for a vehicle according to an embodiment of the present invention. The fluid filtering apparatus 1 is provided at an automatic transmission (not shown) of an automobile for filtering oil circulating within the automatic transmission.

The fluid filtering apparatus 1 includes a resin-made casing 3 substantially in a rectangular shape and a filter element 5 arranged in an inner space R of the casing 3 for filtering oil. The casing 3 is divided at substantially the central part into upper and lower two parts, as shown in FIG. 2, namely, is composed of an assembly of an upper half casing member 7 and a lower half casing member 9. The lower half casing member 9 corresponds to a first casing member of the present invention and the upper half casing member 7 corresponds to a second half casing member of the present invention.

The lower half casing member 9 includes a substantially flat lower wall 9a and a peripheral wall 9b extending upward from the periphery of the lower wall 9a. The lower wall 9a and the peripheral wall 9b are integrally formed and are made of a laser light non-transmitting resin incapable of transmitting laser light. The laser light non-transmitting resin is not limited particularly only if it is a resin capable of absorbing laser light and incapable of allowing it to pass through, and a resin such as nylon 66, nylon 6, or the like colored with a pigment or the like may be employed, for example. Further, a lower pipe portion 11 for communicating with the inner space R of the casing 3 is provided substantially at the central part of the lower wall 9a so as to protrude downward. The lower pipe portion 11 has a lower end opening serving as a fluid inlet 11a for allowing the oil to enter into the inner space R.

A lower flange portion 13 protruding outwards of the casing 3 is formed around the entirety of the upper edge of the peripheral wall 9b of the lower half casing member 9. The upper face of the lower flange portion 13 is substantially flat. A lower contact face 13a as a contact face of the lower flange portion 13 in contact with an upper contact face of an upper flange portion, which will be described later, is formed continuously around the entire outer peripheral part of the upper face of the lower flange portion 13. The lower contact face 13a is in an annular shape continuing around the entire peripheral part of the lower flange portion 13. An element welding face 13b as an inner face of the lower flange portion 13 to which the peripheral part of the filter element 5 is welded is formed further inside the casing 3 than the lower contact face 13a of the upper face of the lower flange portion 13. The element welding face 13b is in an annular shape similar to the lower contact face 13a and is on the same level as the lower contact face 13a.

On the other hand, the upper half casing member 7 includes a substantially flat upper wall 7a and a peripheral wall 7b extending downward from the periphery of the upper wall 7a. The upper wall 7a and the peripheral wall 7b are integrally formed and are made of a laser light transmitting resin capable of transmitting laser light. The laser light transmitting resin is not limited particularly only if it is capable of transmitting laser light, and a resin such as nylon 66, nylon 6, or the like not colored with a pigment or the like may be employed, for example. An upper pipe portion 15 for communicating with the inner space R of the casing 3 is provided at the upper wall 7a so as to protrude upward. The upper pipe portion 15 has an upper end opening serving as a fluid outlet 11a for allowing the oil in the inner space R to flow out.

An upper flange portion 17 protruding outwards of the casing 3 is formed around the entirety of the lower edge of the peripheral wall 7b of the upper half casing member 7. The upper flange portion 17 extends along the lower flange portion 13 in the state in which the upper half casing member 7 and the lower half casing member 9 are assembled. An upper contact face 17a as a contact face of the upper flange portion 17 in contact with the lower contact face 13a is formed continuously around the entire outer peripheral part of the lower face of the upper flange portion 17. Further, a housing concave part 19 in which the peripheral part of the filter element 5 is housed is formed further inside the casing 3 than the upper contact face 17a in the lower face portion of the upper flange portion 17 so as to continue around the entire inner periphery of the upper flange portion 17. The housing concave part 19 is formed by differentiating in level a region other than the upper contact face 17a of the lower face of the upper flange portion 17 from the upper contact face 17a. The depth of the housing concave part 19 is set smaller than the thickness of the peripheral part of the filter element 5. The peripheral part 5a of the filter element 5 is held between the inner face of the housing concave part 19 and the element welding face 13b of the lower flange portion 13 in the state in which the upper half casing member 7 and the lower half casing member 9 are assembled.

The filter element 5 is formed in a rectangular plate shape and is made of fiber (non-woven fabric) of polyester resin capable of transmitting laser light. The peripheral part 5a of the filter element 5 is compressed by heating and pressing to be thin. The filter element 5 has a size to the extent that the peripheral part 5a of the filter element 5 is located in the housing concave part 19 of the upper half casing member 7 as viewed from above.

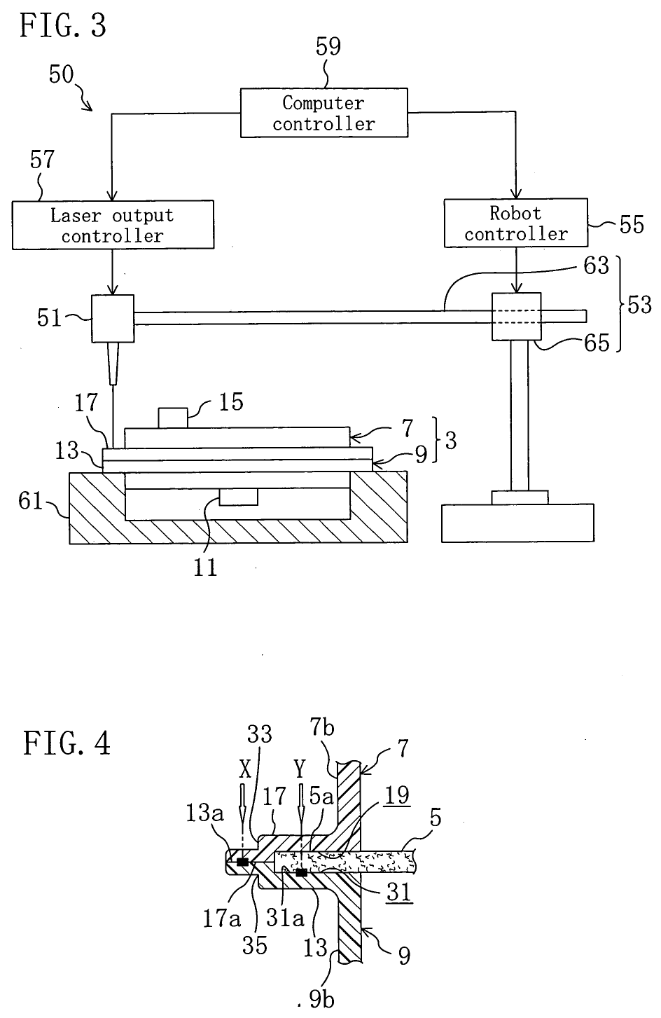

A welding apparatus 50 used for manufacturing the above fluid filtering apparatus 1 will be described next with reference to FIG. 3. The welding apparatus 50 includes: a laser light emitter 51; a robot arm manipulator 53 that moves the laser light emitter 51 along a set track; a robot controller 55 that controls the robot arm manipulator 53; a laser output level controller 57 that controls the output level of the laser light emitter 51; and a computer controller 59 that sends an instruction to the robot controller 55 and the laser output level controller 57. Reference numeral 61 in FIG. 3 denotes a holding jig for holding an object to be welded.

The laser light emitter 51 irradiates laser light having a wavelength capable of melting the laser light non-transmitting resin. The output level of the laser light irradiated from the laser light emitter 51 is changed by the laser output level controller 57. When information for the change is input in the computer controller 59, the computer controller 59 sends an instruction to the laser output level controller 57 to allow the laser output level controller 57 to control the laser light emitter 51 on the basis of the instruction, thereby changing the output level of the laser light irradiated from the laser light emitter 51.

The robot arm manipulator 53 includes a support arm 63 for supporting the laser light emitter 51 so that the laser light emitter 51 travels by moving the support arm 63 by a drive mechanism 65. The moving speed and the moving track of the support arm 63 are controlled by the robot controller 55. Through this control, the traveling speed and the moving track of the laser light emitter 51 are determined. When information for the aforementioned change is input to the computer controller 59, the computer controller 59 sends an instruction to the robot controller 55 to allow the robot controller 55 to manipulate the robot arm manipulator 53 on the basis of the instruction, thereby changing the traveling track and the traveling speed of the laser light emitter 51.

A method for manufacturing the fluid filtering apparatus 1 constructed as above will be described next. First, the peripheral part 5a of the filter element 5 prepared in advance is housed in the housing concave part 19. Then, the upper flange portion 17 of the upper half casing member 17 is put on the lower flange portion 13 of the lower half casing member 9 so that they are held by the holding jig 61 of the welding apparatus 50. In this condition, the peripheral part 5a of the filter element 5 is held between the upper flange portion 9 and the lower flange portion 13 and the upper contact face 17a and the lower contact face 13a are in contact with each other.

Thereafter, the irradiation port of the laser light emitter 51 is positioned right above the upper contact face 17a of the upper flange portion 17 by moving the robot arm manipulator 53. Then, the laser light is irradiated to a welding starting point of the lower contact face 13a by the laser light emitter 51. The laser light emitter 51 irradiating the laser light is allowed to travel one loop above the upper flange portion 17 by moving the robot arm manipulator 53 so as to correspond to the shape of the lower contact face 13a as viewed from above. When the laser light reaches the welding starting point again, the irradiation of the laser light is halted. The above steps serve as a contact face welding step. The direction (indicated by an arrow X in FIG. 1) in which the laser light is irradiated from the laser light emitter 51 is set to a direction intersecting substantially at a right angle with the lower contact face 13a.

The upper half casing member 7 is made of the laser light transmitting resin and both the contact faces 17a, 13a are formed in the flange portions 17, 13 protruding outward from the peripheral walls 7b, 9b, respectively, and therefore, the laser light irradiated from the laser light emitter 51 passes through only the upper flange portion 17 to reach the lower contact face 13a with less or no energy thereof dampened. The energy of the laser light that reaches the lower contact face 13a is absorbed in the lower contact face 13a because the lower half casing member 9 is made of the laser light non-transmitting resin. The lower contact face 13a is heated and melted by the energy of the laser light provided to the lower contact face 13a. The heat of the lower contact face 13a is transferred to the upper contact face 17a of the upper flange portion 17 to melt the upper contact face 17a to some extent. When the melted resins at the lower contact face 13a and the upper contact face 17a are hardened, both the contact faces 17a, 13a are welded to each other, thereby integrating the upper half casing member 7 and the lower half casing member 9 with each other.

After the above described contact face welding step, the irradiation port of the laser light emitter 51 is positioned right above the housing concave part 19 of the upper flange portion 17 by moving the robot arm manipulator 53, and then, the laser light is irradiated to a welding starting point of the element welding face 13b by the laser light emitter 51. The laser light emitter 51 irradiating the laser light is allowed to travel one loop above the upper flange portion 17 by moving the robot arm manipulator 53 so as to correspond to the shape of the element welding face 13b as viewed from above. When the laser light reaches the welding starting point again, the irradiation of the laser light is halted. These steps serve as a filter element welding step. The direction (indicated by an arrow Y in FIG. 1) in which the laser light is irradiated is set to a direction intersecting substantially at a right angle with the element welding face 13b. The traveling speed of the laser light emitter 51 in the element welding step is set substantially equal to the traveling speed of the laser light emitter 51 in the contact face welding step.

The laser light irradiated from the laser light emitter 51 passes through the upper flange portion 17 and the peripheral part 5a of the filter element 5, and then, reaches the element welding face 13b with less or no energy thereof dampened, as well. The energy of the laser light that reaches the element welding face 13b heats and melts the element welding face 13b. The resin melted at the element welding face 13b permeates into the peripheral part 5a of the filter element 5, and then, is hardened, so that the element welding face 13b is welded to the peripheral part 5a of the filter element 5.

In the present embodiment, the filter element 5 has transmittance for laser light lower than the upper half casing member 7, and therefore, the output level of the laser light for irradiation in the filter element welding step is set slightly higher than the output level of the laser light for irradiation in the contact face welding step. This output level setting attains reliable melting of the peripheral part 5a of the filter element 5 to allow it to be welded to the element welding face 13b.

It is noted that in the case where the traveling speed of the laser light emitter 51 in the element welding step is set equal to the traveling speed of the laser light emitter 51 in the contact face welding step, the robot controller 55 may not have a function of controlling the moving speed of the support arm 63.

In the thus manufactured fluid filtering apparatus 1, the oil that flows in the inner space R of the casing 3 from the fluid inlet 11a passes through the filter element 5 to be filtered, and then, flows outside from the fluid outlet 15a. The peripheral part 5a of the filter element 5 is welded to the element welding face 13b to be held thereat, so that the filter element 5 is prevented form falling from the casing 3 in filtering the oil.

As described above, in the present embodiment, the upper half casing member 7 is made of the laser light transmitting resin, so that the laser light irradiated from the laser light emitter 51 passes through the upper flange portion 17 with less or no energy thereof dampened. Further, the element welding face 13b and the lower contact face 13a are formed in the lower flange portion 13 protruding outwards of the casing 3 from the periphery of the lower half casing member 9, so that the laser light can be irradiated in a direction intersecting substantially at a right angle with the element welding face 13b and the lower contact face 13a while avoiding passing through the peripheral wall of one of the casing members in contrast to the conventional one in which the laser light passes therethrough. Whereby, the welding strength at the contact faces 17a, 13a and the welding strength at the peripheral part 5a of the filter element 5 can be ensured with no large-size and high-output laser light emitter necessitated, resulting in a low-cost fluid filtering apparatus.

Moreover, the output level of the laser light is set different between in the contact face welding step and the filter element welding step, resulting in reliable melting of the contact face 13a and the element welding face 13b of the lower flange portion 13 to prevent welding failure of both the flange portions 13, 17 and the peripheral part 5a of the filter element 5.

It is noted that the housing concave part 19 is formed in only the upper half casing member 7 in the present embodiment but an additional housing concave part 31 may be formed in the lower half casing member 9 as shown in a modified example of FIG. 3. In this modified example, the thickness of the filter element 5 is uniform entirely, the housing concave part 31 of the lower half casing member 9 has the same size in inner diameter and depth as the housing concave part 19 of the upper half casing member 7, and an element welding face 31a is formed in the inner face of the housing concave part 31. Also, a step portion 33 is formed at a part of the upper face of the upper flange portion 17 correspondingly to the housing concave part 19 so that the level of the outer peripheral part of the upper face is set lower than that of the inner peripheral part thereof. Further, a step portion 35 is formed at a part of the lower face of the lower flange portion 13 correspondingly to the housing concave part 31. This step portion 35 sets the level of the outer peripheral part of the lower face of the lower flange portion 13 higher than that of the inner peripheral part thereof. The peripheral part 5a of the filter element 5 is held between the inner faces of the housing concave parts 19, 31. Accordingly, the peripheral part 5a of the filter element 5 is welded to the element welding face 31a.

It is noted that in the above modified example, the housing concave part 19 of the upper half casing member 7 may not be formed to make the lower face of the upper flange portion 17 flat.

In the above embodiment, the upper half casing member 7 is made of the laser light transmitting resin while the lower half casing member 9 is made of the laser light non-transmitting resin but it is possible that the upper half casing member 7 is made of a laser light non-transmitting resin while the lower half casing member 9 is made of a laser light transmitting resin, to the contrary. In this case, the laser light emitter 51 is provided under the lower flange portion 13 of the lower half casing member 9 so that the laser light is irradiated to the upper contact face 17a of the upper flange portion 17 and the inner face of the housing concave part 19. Whereby, the peripheral part 5a of the filter element 5 is welded to the inner face of the housing concave part 19.

Moreover, the entirety of the filter element 5 has transmittance for laser light in the above embodiment, but a part where the fluid is filtered may not have transmittance for the laser light while only the peripheral part 5a of the filter element 5 has transmittance for laser light.

In the above embodiment, the filter element welding step is carried out after the contact face welding step. However, the contact face welding step may be carried out after the filter element welding step or both steps may be carried out simultaneously with an additional laser light emitters 51 provided.

Furthermore, the traveling speed of the laser light emitter 51 may be changed between the filter element welding step and the contact face welding step while the output level of the laser light in the filter element welding step is set equal to the output level of the laser light in the contact face welding step. In this case, the traveling speed of the laser light emitter 51 in the filter element welding step is set lower than the traveling speed of the laser light emitter 51 in the contact face welding step. This speed setting allows a sufficient amount of the laser light to pass through the peripheral part 5a of the filter element, thereby attaining reliable melting of the element welding face 13b, as well as in the case where the output level of the laser light is set as above. In the case where the output level is not changed in both the steps, the laser output controller 57 may be dispensed with.

It is also noted that the present invention is applicable for filtering engine oil, for example, besides the application to an automatic transmission for an automobile.

As described above, the present invention is applicable for filtering oil circulating in an automatic transmission of an automobile, for example.

What is claimed is:

1. A fluid filtering apparatus for a vehicle which is provided with a casing composed of a casing member in which a fluid inlet is formed and another casing member in which a fluid outlet is formed and a filter element arranged within the casing for filtering a fluid flowing in the fluid inlet and in which flange portions formed at peripheries of the casing members so as to protrude outwards of the casing are welded to each other to integrated the casing members with each other and to hold the filter member by the casing members, the fluid filtering apparatus characterized in that:
one of the casing members is made of a resin capable of transmitting laser light while the other casing member is made of a resin incapable of transmitting laser light,
contact faces in contact with each other are formed in peripheral parts of the flange portions of the casing members, a housing concave part for housing a peripheral part of the filter element is formed in a part further inside the casing than at least one of the contact faces of the flange portions, at least the peripheral part of the filter element having transmittance for laser light, and
the contact face of the flange portion of the other casing member is welded to the contact face of the flange portion of the one casing member by melting the contact face of the flange portion of the other casing member by irradiating laser light to the contact face of the flange portion of the other casing member through the flange portion of the one casing member while an inner face located inside the flange portion of the other casing member is welded to the peripheral part of the filter element by melting the contact face of the flange portion of the other casing member by irradiating laser light to the contact face of the flange portion of the other casing member through the flange portion of the one casing member.

2. A method for manufacturing the fluid filtering apparatus for a vehicle according to claim 1, comprising the steps of:
allowing the contact faces formed in the peripheral parts of the flange portions of the casing members to be in contact with each other while housing the peripheral part of the filter element into the housing concave part formed in a part further inside the casing than at least one of the contact faces of the flange portions; and
thereafter, welding the contact face of the flange portion of the other casing member to the contact face of the flange portion of the one casing member by melting the contact face of the flange portion of the other casing member by irradiating laser light to the contact face of the flange portion of the other casing member through the flange portion of the one case member and welding the inner face located inside the flange portion of the other casing member to the peripheral part of the filter element by melting the inner face located inside the flange portion of the other casing member by irradiating laser light to the inner face located inside the flange portion of the other casing member. through the flange portion of the one casing member.

3. A method for manufacturing the fluid filtering apparatus for a vehicle according to claim 2,
wherein the contact faces of the flange portions are welded to each other and the inner face located inside the flange portion of the other casing member is welded to the peripheral part of the filter element under a condition that:
traveling speed of the laser light traveling along the periphery part of the filter element in welding the peripheral part of the filter element to the inner face located inside the flange portion of the other casing member is set lower than traveling speed of the laser light traveling along the contact faces of the flange portions in welding the contact faces of the flange portions to each other; or
an output level of the laser light for irradiation in welding the peripheral part of the filer element to the inner face located inside the flange portion of the other casing member is set higher than an output level of the laser light for irradiation in welding the contact faces of the flange portions to each other.
